(19) United States
(12) Patent Application Publication
(10) Pub. No.: US 2009/0064511 A1
(43) Pub. Date: Mar. 12, 2009

(54) Collapsible handle saw apparatus

(76) Inventor: W. Scott Crawford, Sarasota, FL (US)

Correspondence Address: S. Michael Bender, P.O. Box 530-399, St. Petersburg, FL, 33747, US

(21) Appl. No.: 11/899,416

(22) Filed: Sep. 7, 2007

(51) Int. Cl. B23D 51/01; B27B 21/00

(52) U.S. Cl. 30/517; 30/162

(57) ABSTRACT

A collapsible handle saw apparatus includes a saw unit which has a saw blade portion and a handle unit attachment portion. The handle unit attachment portion has a male or female attachment end. A plurality of handle units are provided, wherein each handle unit includes a male or female attachment end and an opposite female or male attachment end. Flexible, foldable, internal, linear connector means are threaded through the plurality of handle units. The flexible, foldable, internal, linear connector means include a first end and a second end. With the first handle unit, the first end is connected to the saw unit. A cinching/locking unit is provided which receives the second end of the flexible, foldable, internal, linear connector means. When unerected, the collapsible handle saw apparatus is small enough to fit into a backpack. In addition, the apparatus is easy to erect without the need for any tools.

### BACKGROUND OF THE INVENTION

1. Field of the Invention

The present invention relates generally to saws, and, more particularly, to saws having relatively long handles.

2. Description of the Prior Art

Implements having long handles are well known in the art. Throughout the years, a number of innovations have been developed relating to devices having long handles, and the following U.S. patents are representative of some of those innovations: U.S. Pat. No. 3,730,544, U.S. Pat. No. 4,653,142, U.S. Pat. No. 5,582,899, and U.S. Pat. No. 5,933,965.

More specifically, U.S. Pat. No. 3,730,544 discloses a collapsible ski pole. Even more specifically, an internal cable is threaded through a plurality of pole units, each of which has a male end and a female end. In an unerected condition, the internal cable is in a slack condition, and the pole units are disconnected from each other. On the other hand, in the erected condition, male ends of pole units are connected to respective female ends of adjacent pole units, and the internal cable is tightened to maintain the pole in the erected condition. Although these principles are set forth for a ski pole, there is no disclosure of a saw having a collapsible handle that employs the principles of having an internal cable which is threaded through a plurality of handle units, each of which has a male connection end and a female connection end.

U.S. Pat. No. 4,653,142 discloses a saw that has an extendible handle. More specifically, a plurality of telescopic handle units are nested within each other. In the unerected condition, the telescopic handle units are fully nested within each other. On the other hand, in the erected condition, only ends of the telescopic handle units are nested within each other. One deficiency of having a plurality of nested telescopic handle units is that each successive handle unit that is nested within an adjacent handle unit has a smaller diameter than the adjacent handle unit into which the successive handle unit is nested. As a result, each successive handle unit has less strength than an adjacent handle unit. Moreover, the overall weight of such an extendible handle is relatively heavy because of the weight of the material that is present in the nesting handle units. In this respect, it would be desirable to provide a collapsible handle for a saw that does not include nestable telescopic handle units having successively smaller diameters.

U.S. Pat. No. 5,582,899 discloses a long-handled groove maker for concrete. The long handle is comprised of a plurality of handle units that screw together. Each of the plurality of handle units is relatively long. That is, each of the plurality of handle units is much too long to fit into a backpack. More specifically, for hunters, hikers, campers, and other outdoorsmen, it would be desirable to provide a collapsible handle saw apparatus that, when unerected, is small enough to fit into a backpack, and that is easy to erect without the need for any tools.

U.S. Pat. No. 5,933,965 discloses an extendable pruning tool which has a scissors-like cutting end. This tool combines a noncollapsible long handle portion with a telescopically extending pruning tool end. Clearly this pruning tool cannot be collapsed sufficiently to fit into a backpack.

U.S. Pat. No. 4,630,373 is of interest for its disclosure of a saw that has a handle into which a saw blade can be retracted. Clearly, the handle itself is not collapsible or extendable.

Still other features would be desirable in a collapsible handle saw apparatus. For example, hunters often set up tree stands in trees. Also, often the climbing lanes to the tree stands get overgrown with tree branches. In this respect, it would be desirable to provide a hunter with a collapsible saw that he could remove from his backpack and erect onsite to cut tree branches that have overgrown the climbing lanes to tree stands.

Another desirable feature of a collapsible handle saw apparatus would be to have the outside surfaces of the handle units to be camouflaged. Often, a hunter wears camouflage clothing, and it would be desirable if the collapsible handle saw apparatus were also camouflaged so that use of the collapsible handle saw apparatus would not scare off wildlife.

Thus, while the foregoing body of prior art indicates it to be well known to use cutting devices have long handles, the prior art described above does not teach or suggest a collapsible handle saw apparatus which has the following combination of desirable features: (1) has a collapsible handle that employs an internal cable which is threaded through a plurality of handle units, each of which has a male connection end and a female connection end; (2) has a collapsible handle for a saw that does not include nesting telescopic handle units having successively smaller diameters; (3) when unerected, is small enough to fit into a backpack, and that is easy to erect without the need for any tools; (4) can be removed from a backpack and erected onsite to cut tree branches that have overgrown the climbing lanes to tree stands; and (5) can be camouflaged so that use of the collapsible handle saw apparatus would not scare off wildlife. The foregoing desired characteristics are provided by the unique collapsible handle saw apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a collapsible handle saw apparatus which includes a saw unit which has a saw blade portion and a handle unit attachment portion. The handle unit attachment portion has a male or female attachment end. A plurality of handle units are provided, wherein each handle unit includes a male or female attachment end and an opposite female or male attachment end. Flexible, foldable, internal, linear connector means are threaded through the plurality of handle units. The flexible, foldable, internal, linear connector means include a first end and a second end. With the first handle unit, the first end is connected to the saw unit. A cinching/locking unit is provided which receives the second end of the flexible, foldable, internal, linear connector means. When unerected, the collapsible handle saw apparatus is small enough to fit into a backpack. In addition, the apparatus is easy to erect without the need for any tools.

Preferably, a saw blade cover is provided for covering the saw blade portion.

Preferably, the flexible, foldable, internal, linear connector means include a nylon cord. Preferably, the nylon cord includes a loop handle portion.

Preferably, the male or female attachment end of the saw unit is a male attachment end. Also, one end of each of the handle unit attachment ends is a female attachment end, and one end of each of the handle unit attachment ends is a male attachment end.

Preferably, the male or female attachment end of the cinching/locking unit is a male attachment end.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved collapsible handle saw apparatus which has all of the advantages of the prior art and none of the disadvantages.

It is another object of the present invention to provide a new and improved collapsible handle saw apparatus which may be easily and efficiently manufactured and marketed.

It is a further object of the present invention to provide a new and improved collapsible handle saw apparatus which is of durable and reliable construction.

An even further object of the present invention is to provide a new and improved collapsible handle saw apparatus which is susceptible of a low cost of manufacture with regard to both materials and labor, and which accordingly is then susceptible of low prices of sale to the consuming public, thereby making such collapsible handle saw apparatus available to the buying public.

Still yet a further object of the present invention is to provide a new and improved collapsible handle saw apparatus which has a collapsible handle that employs an internal cable which is threaded through a plurality of handle units, each of which has a male connection end and a female connection end.

Still another object of the present invention is to provide a new and improved collapsible handle saw apparatus that has a collapsible handle for a saw that does not include nesting telescopic handle units having successively smaller diameters.

Yet another object of the present invention is to provide a new and improved collapsible handle saw apparatus which when unerected, is small enough to fit into a backpack, and that is easy to erect without the need for any tools.

Even another object of the present invention is to provide a new and improved collapsible handle saw apparatus that can be removed from a backpack and erected onsite to cut tree branches that have overgrown the climbing lanes to tree stands.

Still a further object of the present invention is to provide a new and improved collapsible handle saw apparatus which can be camouflaged so that use of the collapsible handle saw apparatus would not scare off wildlife.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the collapsible handle saw apparatus of the invention in an erected condition.

FIG. 2 is an enlarged side view of a portion of the collapsible handle saw apparatus shown in FIG. 1, contained in circled region 2 of FIG. 1.

FIG. 3 is an enlarged side view of a portion of the collapsible handle saw apparatus shown in FIG. 1, contained in circled region 3 of FIG. 1.

FIG. 4 is an enlarged side view of a portion of the collapsible handle saw apparatus shown in FIG. 1, contained in circled region 4 of FIG. 1.

FIG. 5 is a side view of the embodiment of the invention shown in FIG. 1, in an unerected condition.

### DESCRIPTION OF THE PREFERRED EMBODIMENT

With reference to the drawings, a new and improved collapsible handle saw apparatus embodying the principles and concepts of the present invention will be described.

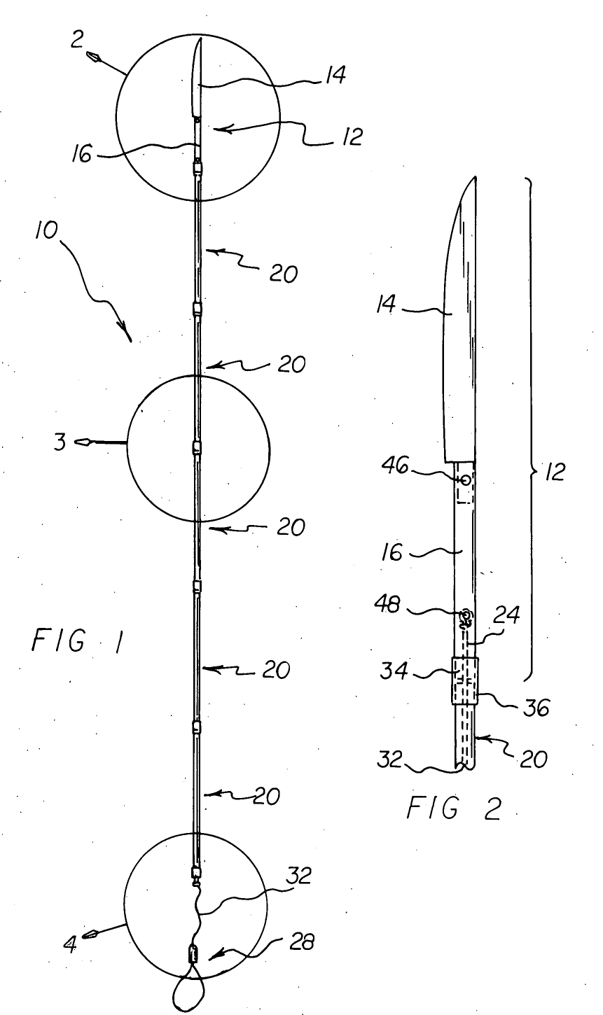

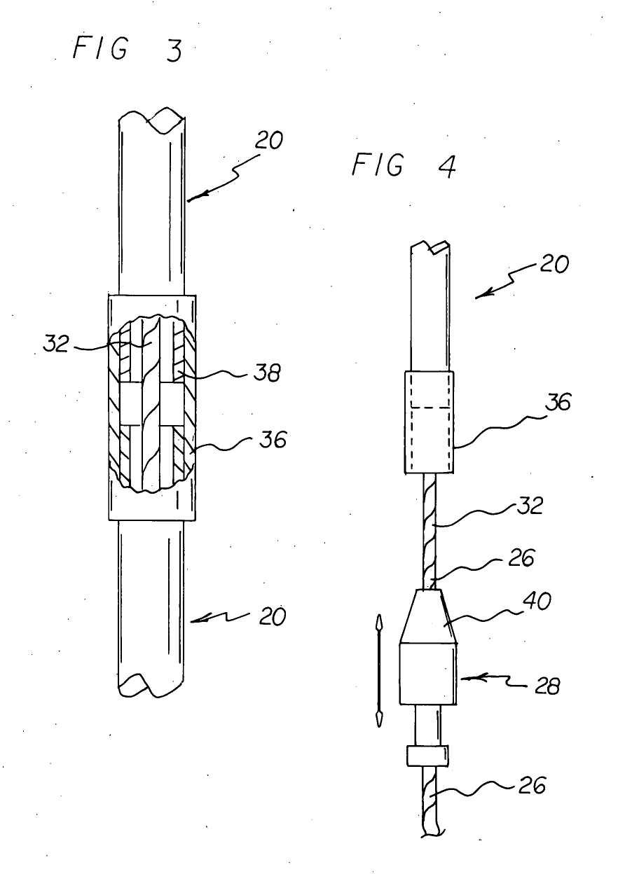

Turning to FIGS. 1-5, there is shown a preferred embodiment of the collapsible handle saw apparatus of the invention generally designated by reference numeral 10. In each of the figures, reference numerals are shown that correspond to like reference numerals that designate like elements shown in other figures.

In the preferred embodiment, collapsible handle saw apparatus 10 includes a saw unit 12 which has a saw blade portion 14 and a handle unit attachment portion 16. The handle unit attachment portion 16 has a male or female attachment end. A plurality of handle units 20 are provided, wherein each handle unit 20 includes a male or female attachment end and an opposite female or male attachment end. Flexible, foldable, internal, linear connector means are threaded through the plurality of handle units 20. The flexible, foldable, internal, linear connector means include a first end 24 and a second end 26. With the first handle unit 20, the first end 24 is connected to the saw unit 12. A cinching/locking unit 28 is provided which receives the second end 26 of the flexible, foldable, internal, linear connector means.

The cinching/locking unit 28 is a conventional commercial cinching unit 28 which includes linear connector locking means, linear connector unlocking means, and a male attachment end 40 for attaching to a complementary female attachment end 36 of a handle unit 20. Preferably, a saw blade cover 42 is provided for covering the saw blade portion 14.

Preferably, the flexible, foldable, internal, linear connector means includes a nylon cord 32. Preferably, the nylon cord 32 includes a loop handle portion 44.

The flexible, foldable, internal, linear connector means can be selected from the group consisting of cords, cables, ropes, and chains, among others. Preferably, the male or female attachment end of the saw unit 12 is a male attachment end 34. Also, one end of each of the handle unit attachment ends is a female attachment end 36, and one end of each of the handle unit attachment ends is a male attachment end 38.

Preferably, the male or female attachment end of the cinching/locking unit 28 is a male attachment end 40.

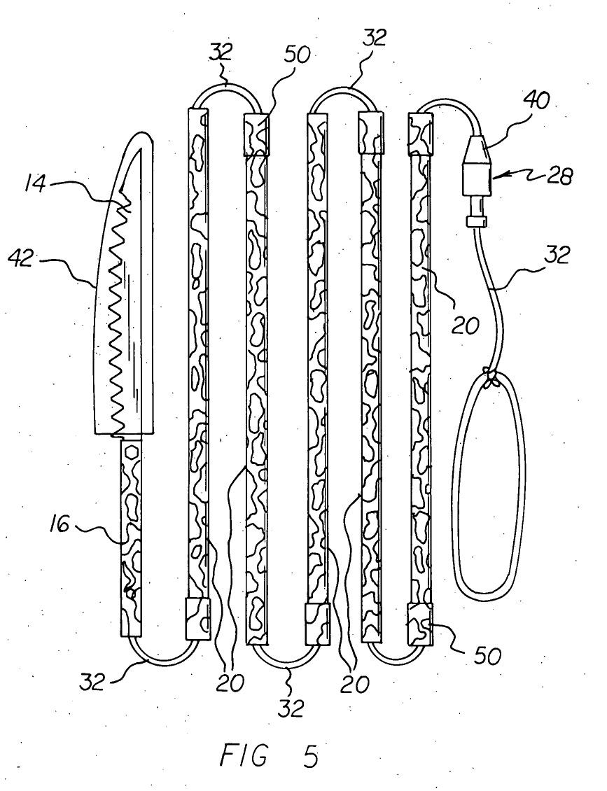

To operate the collapsible handle saw apparatus 10, the apparatus 10 would first be in an unerected or folded or collapsed condition, as shown in FIG. 5. In the collapsed condition, the collapsible handle saw apparatus 10 can be easily stored in a backpack (not shown). In addition, the collapsed apparatus 10 can be stored in a separate storage bag (not shown). The separate storage bag, with the collapsed apparatus 10 therein, can be stored in a backpack.

When the collapsible handle saw apparatus 10 is removed from its storage location, the saw unit 12 and the handle units 20 are placed in alignment so that the male attachment end 34 of the saw blade portion 14 is placed in a female attachment end 36 of the adjacent handle unit 20. Then, respective male attachment ends 38 and respective female attachment ends 36 of successive handle units 20 are fitted together. Then, the male attachment end 40 is placed in the female attachment end 36 of the last handle unit 20 so that all of the rigid components of the collapsible handle saw apparatus 10 are placed together. Then, the cinching/locking unit 28 is grasped in one hand, and the loop handle portion 44 is grasped in the other hand. Then, the loop handle portion 44 is pulled away from the cinching/locking unit 28 so that the nylon cord 32 becomes taut. Once the nylon cord 32 is taut, the collapsible handle saw apparatus 10 is fully erected and locked into the erect condition.

Then, the saw blade cover 42 is removed from the saw blade portion 14, and handle units 20 are grasped by the user. Then, the saw blade portion 14 is used to cut off branches from a tree.

When the collapsible handle saw apparatus 10 is no longer needed, the saw blade cover 42 is placed back on the saw blade portion 14. Then, the cinching/locking unit 28 is operated to loosen the grip of the cinching/locking unit 28 on the second end 26 of the nylon cord 32 so that tautness in the nylon cord 32 is removed. Then, with the cinching/locking unit 28 still loosened from the nylon cord 32, the nylon cord 32 is pulled through the cinching/locking unit 28 in the direction of the handle units 20. Then, enough of the nylon cord 32 is pulled toward the handle units 20 so that the handle units 20 can be folded around the loose nylon cord 32, such as shown in FIG. 5 to be in the unerected, collapsed, and folded condition. Then, the apparatus can be placed in a special bag and placed in a backpack.

Each of the handle unit attachment portion 16 and the plurality of handle units 20 can include a camouflage exterior surface.

When erected, the collapsible handle saw apparatus 10 can be up to 8 feet long, or longer.

Each of the handle units 20 can be made from ½ inch rigid tubing, e.g. metal tubing. To form female attachment ends 36 to the handle units 20. A short ½ inch slip coupling 50 is attached on one end of a handle unit 20. The slip coupling can be attached using an adhesive, such as an epoxy adhesive. Alternatively, the slip coupling can be welded to the rigid tubing. Each of the handle units 20 can be approximately 13 inches long.

The saw blade portion 14 can be attached to the handle unit attachment portion 16 using a nut and bolt 46. In addition, the first end 24 of the nylon cord 32 can be attached to the handle unit attachment portion 16 with another nut and bolt 48.

The components of the collapsible handle saw apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved collapsible handle saw apparatus that is low in cost, relatively simple in design and operation, and which may advantageously be used to employ an internal cable which is threaded through a plurality of handle units, each of which has a male connection end and a female connection end. With the invention, a collapsible handle saw apparatus is provided which has a collapsible handle for a saw that does not include nesting telescopic handle units having successively smaller diameters. With the invention, a collapsible handle saw apparatus is provided which when unerected, is small enough to fit into a backpack, and that is easy to erect without the need for any tools. With the invention, a collapsible handle saw apparatus is provided which can be removed from a backpack and erected onsite to cut tree branches that have overgrown the climbing lanes to tree stands. With the invention, a collapsible handle saw apparatus is provided which can be camouflaged so that use of the collapsible handle saw apparatus would not scare off wildlife.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A collapsible handle saw apparatus, comprising:
a saw unit having a saw blade portion and a handle unit attachment portion, wherein said handle unit attachment portion has a male or female attachment end,
a plurality of handle units, wherein each handle unit includes a male or female attachment end and an opposite female or male attachment end,
flexible, foldable, internal, linear connector means threaded through said plurality of handle units, wherein said flexible, foldable, internal, linear connector means include a first end and a second end, wherein said first end is connected to said saw unit, and
a cinching/locking unit which receives said second end of said flexible, foldable, internal, linear connector means.

2. The apparatus of claim 1, further including:
a saw blade cover for covering said saw blade portion.

3. The apparatus of claim 1 wherein said flexible, foldable, internal, linear connector means include a nylon cord.

4. The apparatus of claim 3 wherein said nylon cord includes a loop handle portion.

5. The apparatus of claim 1 wherein:
said male or female attachment end of said saw unit is a male attachment end,
one end of each of said handle unit attachment ends is a female attachment end, and
one end of each of said handle unit attachment ends is a male attachment end.

6. The apparatus of claim 1 wherein said male or female attachment end of said cinching/locking unit is a male attachment end.
